(19) United States
(12) Patent Application Publication
(10) Pub. No.: US 2024/0320913 A1
(43) Pub. Date: Sep. 26, 2024

(54) METHOD FOR GENERATING A THREE-DIMENSIONAL MODEL OF AN OBJECT FOR CONTROLLING A 3D PRINTER

(71) Applicant: Hyperforge Holdings Pte Ltd., Singapore (SG)

(72) Inventor: Michael GALLO, Valeggio sul Mincio (IT)

(21) Appl. No.: 18/606,518

(22) Filed: Mar. 15, 2024

Related U.S. Application Data
(63) Continuation of application No. PCT/EP2022/075648, filed on Sep. 15, 2022.

(30) Foreign Application Priority Data
Sep. 16, 2021 (DE) 10 2021 124 009.3

(51) Int. Cl. G06T 17/00; B33Y 50/02

(52) U.S. Cl. CPC G06T 17/005; B33Y 50/02

(57) ABSTRACT

A method is provided for generating a 3D model of a physical object for controlling a 3D printer by means of control instructions, derived from the generated 3D model, for printing the object in the 3D printer, a surface representation of the physical object being converted into a voxel model representing the 3D model.

### CROSS REFERENCE TO RELATED APPLICATIONS

This application is a continuation under 35 U.S.C. § 120 of International Application PCT/EP2022/075648, filed Sep. 15, 2022, which claims priority to German Application No. 10 2021 124 009.3, filed Sep. 16, 2021, the contents of each of which are incorporated by reference herein.

### FIELD OF THE INVENTION

The invention relates to a method for generating a 3D model of a physical object. Control instructions derived from the generated 3D model can be used to control a 3D printer in order to print the object in the 3D printer.

### BACKGROUND OF THE INVENTION

In the field of 3D printing, it is common practice to represent physical objects (i.e., objects to be printed in a 3D printer) with virtual 3D models. For example, it is known to describe the surface of a physical object in the 3D model using a number of triangles—this type of object representation is also known as surface triangulation. An alternative way to represent a physical object by means of a 3D model is to use curves that describe the surfaces of the physical object in the 3D model, such as Bézier curves. Print data can be derived from the 3D models, which can be interpreted by the 3D printer in order to print the object.

The aforementioned types of object representation are suitable for generating 3D models that are as realistic as possible in a computer-aided design application. However, the disadvantage here is that, for example, transformations that have to be applied to the 3D model are very computationally intensive. Complex operations, such as simulating the deformation of a 3D model due to external forces acting on the 3D model, are even more computationally intensive and in many cases can only be carried out efficiently if sufficient RAM and computing power are available.

Another disadvantage of the object representations mentioned is that the 3D models only describe the surface itself, but not the volume of the object within the surface. This disadvantage means that internal volume areas that are to be printed with a different material, for example, must be described as independent 3D models. The same applies to surface areas that are to be printed with the same material as the other surface areas but with a different color—in this case, each surface area that has a different color than the adjacent surface areas must be described in a separate 3D model. These separate 3D models must be merged for printing.

### Object of the Invention

The object of the present invention is therefore to provide a method for generating a 3D model of a physical object (i.e., an object to be printed in a 3D printer), which avoids the aforementioned disadvantages and enables easier and more flexible manipulation of the 3D model.

### Solution According to the Invention

The object is achieved by a method having the features according to the independent claim. Advantageous further embodiments of the invention are given in the dependent claims.

Accordingly, there is provided a method for generating a 3D model of a physical object (i.e., an object to be printed in a 3D printer) for controlling a 3D printer by means of control instructions, derived from the generated 3D model, for printing the object in the 3D printer, wherein a surface representation of the physical object is converted into a voxel model representing the 3D model, wherein
the surface representation is divided into a number of volume areas, wherein each volume area is represented by a first tree structure, wherein the first tree structure
comprises at least one root node, and
has a predetermined maximum first number of hierarchy levels and a predetermined second number of sub-nodes can be assigned to each node of a hierarchy level, wherein
the root node represents the volume area,
the sub-nodes of the root node represent partial volume areas of the volume area represented by the root node,
the sub-nodes of a sub-node represent partial volume areas of the partial volume area represented by the respective sub-node, and
the volume area and the partial volume areas each represent a voxel of the voxel model,
each voxel is assigned a distance attribute in which the distance of the respective voxel to the surface of the object can be stored, wherein a minimum distance to the surface of the object is determined for each voxel when the voxel model representing the 3D model is generated, wherein
for each voxel whose minimum distance is below a predetermined threshold value, the distance is stored in the distance attribute,
for each voxel whose absolute minimum distance is above the predetermined threshold value, a predetermined distance is stored in the distance attribute, and
for each partial volume area, the distance and/or the predetermined distance of the respective voxels is only stored if it (i.e., the distance and/or the predetermined distance) additionally fulfills a predetermined storage criterion, and wherein
the control instructions for controlling the 3D printer are derived from the first tree structure and the voxels stored in the first tree structure, wherein the control instructions comprise information about the areas in a print space of the 3D printer at which a print material belongs to the object, wherein these areas are determined by those voxels for which a distance is stored in the distance attribute, and
the control instructions are provided for transmission to the 3D printer.

In a particular embodiment of the method according to the invention, the number of volume areas can be one, i.e., the one volume area can be used to describe the entire volume of the object to be printed (i.e., the entire object to be printed).

However, for larger objects to be printed or for objects that need to be printed with a particularly high resolution (e.g., due to a particularly high level of detail), it can be advantageous to divide the surface representation of the object to be printed into several volume areas. A substantial advantage here is that the individual volume areas can be processed in parallel, which in particular has a positive effect on the processing speed-operations that are applied to the voxel model can thus be carried out with particularly high performance.

The first tree structure is used to divide the volume area into a number of voxels (the partial volume areas). A voxel describes a cuboid section of the volume area. In a particular embodiment of the invention, the voxels can be cube-shaped. A voxel can in turn be subdivided into a number of voxels (partial volume areas of the partial volume areas).

The number of hierarchy levels can be used to “control” the granularity or resolution of the voxel model. This means that for a constant volume area defined by the root node, the resolution of the volume increases as the number of hierarchy levels increases. Since each voxel has a certain storage requirement (to store the information of the voxel), the storage requirement for the entire voxel model can also be “controlled” using the hierarchy levels. Another way to control the storage requirements for a voxel model is explained below.

The distance stored in the distance attribute indicates that the respective voxel belongs to the surface of the object to be printed. The predetermined distance stored in the distance attribute indicates that the respective voxel does not belong to the surface of the object to be printed.

The stored distance can be the minimum distance.

Storing the distance (or the minimum distance) and the predetermined distance in the distance attribute has the advantage that, when the voxel model is manipulated, only those voxels that belong to the surface need to be processed. The voxels that do not belong to the surface can be ignored during processing, which can significantly improve processing performance. An example of such processing or manipulation would be, for example, generating a texture (e.g., a three-dimensional texture) on the surface of the object to be printed.

If the distance (or the minimum distance) and/or the predetermined distance are only stored for voxels of a partial volume area if they (i.e., the distance or the predetermined distance) fulfill a predetermined storage criterion, the storage requirement for a voxel model can be significantly reduced. On the other hand, the performance of the processing can also be further improved. If, for example, all voxels of a partial volume area have the same predetermined distance to the surface, then it is not necessary to store the predetermined distance in the respective distance attribute—the predetermined distance to the surface can then be stored as required in the voxel that represents this partial volume area (i.e., in the voxel higher or above it in the hierarchy). When processing the voxel model, only the voxel above it needs to be processed.

In one embodiment of the invention, it may be advantageous if
the predetermined maximum number of hierarchy levels is three, such that the first tree structure has a maximum of three hierarchy levels, wherein the root node is the first hierarchy level,
the predetermined number of sub-nodes is 4096, such that 4096 sub-nodes can be assigned to each node of a hierarchy level, with the exception of the lowest hierarchy level,
the nodes of the second hierarchy level represent 4096 first partial volume areas of the volume area,
the nodes of the third hierarchy level each represent 4096 second partial volume areas of the respective first partial volume area.

Each node of a hierarchy level, with the exception of the lowest hierarchy level, is preferably assigned 16×16×16 sub-nodes (16 sub-nodes in each spatial dimension x, y, z). Alternatively, 32×32×4 sub-nodes (or other combinations resulting in 4096 sub-nodes) can also be assigned. The advantage here is that a high resolution of the total volume or the respective volume areas is achieved even with only three hierarchy levels.

Experiments have shown that the first tree structures, each representing a volume area, have approximately the same number of nodes (on the second and third hierarchy levels) (if not all nodes are stored in accordance with the storage criteria mentioned below), such that for processing or calculating the number of volume areas, the first tree structures are each assigned to a different processor core and at the same time it is ensured that all processor cores have completed the calculations after approximately the same time. This means that all processor cores can be optimally utilized. If there are more initial tree structures to be processed than there are processor cores, it is also possible to prevent the processor cores from being unevenly utilized.

4096 sub-nodes can be accommodated in 8 KB of RAM with 2 bytes per sub-node. It has been shown that 4096 sub-nodes ensure a largely optimal utilization of the working memory, i.e., on average the least amount of the 8 kB working memory remains unused compared to other values for the number of sub-nodes.

However, it can also be advantageous if the number of first partial volume areas and the number of second partial volume areas are different. For example, the second hierarchy level may have 8 first partial volume areas and the third hierarchy level may have 4096 second partial volume areas for each first partial volume area. This allows a 3D model to be described on the second hierarchy level with a relatively coarse resolution, while it can be described on the third hierarchy level with a high resolution.

In a further embodiment, it can be advantageous if at least some nodes of the second hierarchy level are assigned a different number of sub-nodes (of the third hierarchy level). For example, some nodes of the second hierarchy level can be assigned 4096 sub-nodes each, while the other nodes of the second hierarchy level can be assigned 8, 64 or 512 sub-nodes each. This allows different volume areas of the 3D model to be represented with different spatial resolutions.

The aforementioned variants with regard to the number of sub-nodes can also be combined.

The predetermined storage criterion may be selected from the group of storage criteria comprising at least
the minimum distance of the voxel is different from the minimum distances of the other voxels of the respective partial volume area (then the distance and/or the predetermined distance is stored for each voxel of the partial volume area),
the difference between the voxel with the smallest minimum distance and the voxel with the largest minimum distance of the respective partial volume range is above a predetermined second threshold value (even then, the distance and/or the predetermined distance is stored for each voxel of the partial volume area).

If the minimum distances of the voxels of a partial volume area are different from one another and the difference between the voxel with the smallest minimum distance and the voxel with the largest minimum distance is below a predetermined second threshold value, then the distance and/or the predetermined distance in the voxels of the partial volume range do not need to be stored. In this case, a common distance (e.g., an average value of the distances) or the predetermined distance can be stored in the voxel above (i.e., in the corresponding voxel on the hierarchy level above). In particular for large contiguous volume areas outside or inside the surface of the 3D model, this can lead to a considerable reduction in storage requirements and the computing power needed.

The second threshold value can correspond to the print resolution of the 3D printer, preferably to a maximum of half the print resolution of the 3D printer.

This means that the storage requirement for storing the 3D model can be dynamically adapted to the print resolution of different 3D printers.

It can be advantageous if the predetermined distance comprises a predetermined first distance (d_{+∞}) and a predetermined second distance (d_{-∞}), wherein
for voxels lying outside the surface of the object, the predetermined first distance (d_{+∞}) (the predetermined first distance is preferably identical for all voxels lying outside the surface), and
for voxels lying within the surface of the object, the predetermined second distance (d_{-∞}) (the predetermined second distance is preferably identical for all voxels lying within the surface) is stored in the distance attribute. A voxel lies outside or inside the surface of the object if it has a certain distance from the surface.

It is advantageous if the position of the first tree structure in three-dimensional space is stored in the root node in relation to the voxel model representing the 3D model. The position is used to store the position and orientation of the voxel model in three-dimensional space. If the size of the voxels of the partial volume areas is known or if the resolution of the partial volume areas is known and if the size of the partial volume areas is known, the position in three-dimensional space can be determined for each voxel using the position stored in the root node without having to store the respective position for the voxels.

In one embodiment of the invention, a further attribute can be assigned to each voxel, wherein a property of the respective voxel is stored in the further attribute.

The property may be selected from the group comprising at least color, material, and combinations thereof, wherein the properties are not limited to the properties mentioned herein.

It has proven to be advantageous if the further attribute is stored in a second tree structure, wherein the second tree structure and the first tree structure represent the same volume area.

The number of hierarchy levels of the first tree structure and the number of hierarchy levels of the second tree structure can be identical. A predetermined third number of sub-nodes can be assigned to each node of a hierarchy level of the second tree structure.

The predetermined third number of sub-nodes can be different from the predetermined second number of sub-nodes (of the first tree structure).

Providing a further tree structure for a further attribute has the advantage that properties of the voxels of a 3D model can be stored in different resolutions, which enables optimized storage requirements. If, for example, an object to be printed consists of only two materials, with large contiguous volume areas consisting of the same material, this property can be stored efficiently with low storage requirements (in the second tree structure with low resolution). However, the distances of the voxels to the surface of the same object to be printed can be stored in the first tree structure with high resolution.

Providing a further tree structure also offers considerable advantages in terms of processing efficiency. On the one hand, the tree structures can be processed in parallel when transformations are applied to a 3D model. On the other hand, the calculation operations can be minimized if each tree structure has the optimal resolution for the respective property of the voxels.

The control instructions may comprise information on the properties stored in the further attribute.

The group of storage criteria may further comprise that the attribute value of the further attribute is different from the attribute values of the further attribute of the remaining voxels of the respective partial volume area. This means that the further tree structures can also be optimized in terms of their storage requirements.

### BRIEF DESCRIPTION OF THE FIGURES

Further details and features of the method according to the invention, as well as specific, in particular advantageous embodiments of the method according to the invention result from the following description in conjunction with the drawings. In the figures:

FIG. 1 shows a system for generating a voxel model representing a 3D model;

FIG. 2 shows an example of a voxel model with an associated tree structure;

FIG. 3 shows an example level of a voxel model to illustrate the storage of the distance attributes; and

FIG. 4 shows the section of a tree structure corresponding to the example in accordance with FIG. 3.

### DETAILED DESCRIPTION OF THE INVENTION

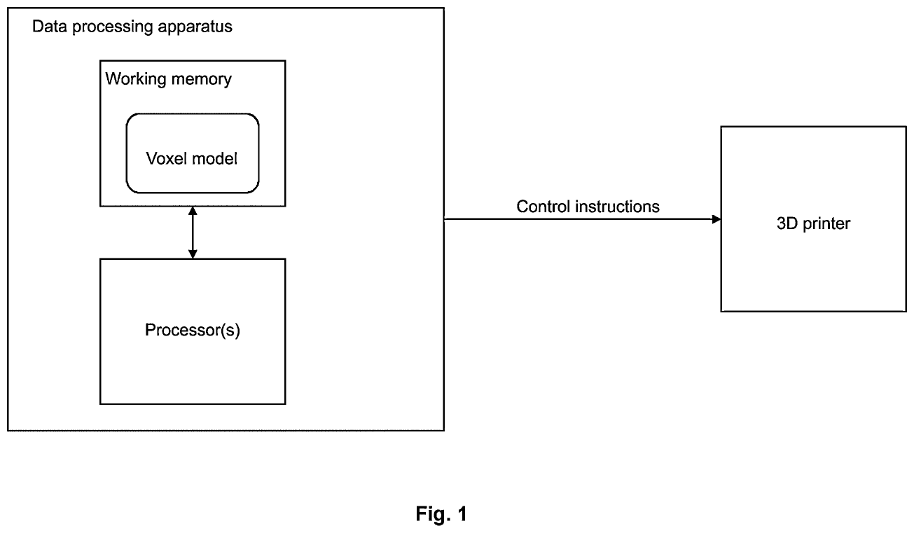

FIG. 1 shows an example of a system for generating a voxel model representing a 3D model.

The system here consists of a data processing apparatus and a 3D printer. The data processing apparatus generates control instructions and transfers them to the 3D printer. 3D printers are well known from the prior art. The control instructions are used to cause the 3D printer to print, i.e., produce, a (physical) object. The control instructions are generated by the data processing apparatus depending on the 3D printer used.

Of the data processing apparatus, only the components necessary for the method according to the invention are shown in FIG. 1, namely a storage apparatus, which is designed here as a working memory, and one or more processors. The term “multiple processors” here also refers to a processor with multiple processor cores.

However, due to the advantageous embodiment of the voxel model, as described in more detail below, the method according to the invention can also be carried out efficiently on a processor with only one processor core. However, multiple processors and/or processors with multiple processor cores are advantageous in terms of parallel processing, for example if transformations or other operations modifying the 3D model have to be carried out on the 3D model represented by one or more tree structures. Several tree structures can thus be processed in parallel.

The tree structures representing the 3D model are stored in the working memory.

The voxel model according to the invention or the tree structures storing the voxel model are designed such that, on the one hand, efficient storage of the voxel model and, on the other hand, efficient processing of the voxel model are ensured. As will be explained in more detail below, not every voxel of the voxel model needs to be stored, which leads to a considerable reduction in the data to be stored and thus to a significantly higher performance calculation of operations to be performed on the voxel model.

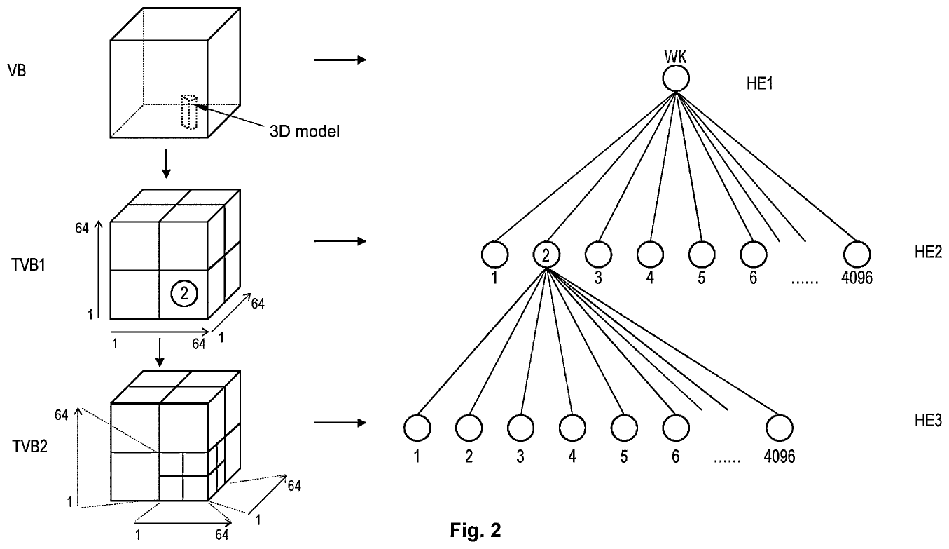

FIG. 2 shows an example of a voxel model according to the invention with an associated tree structure.

The voxel model comprises a volume area VB, which in this case describes a cube-shaped space in which the 3D model is arranged (or in which the object to be printed is modeled).

For larger objects to be printed, several volume areas VB can also be provided, each comprising a part of the 3D model. This has the technical advantage that the multiple volume areas can be processed in parallel, for example when operations such as transformations are carried out on the 3D model.

The volume area VB is described using a tree structure or stored in a tree structure, wherein a root node WK of the tree structure represents the volume area VB as such. The tree structure has several hierarchy levels HE1, HE2, HE3, with the root node representing the top or first hierarchy level HE1.

The position (for example, the 3D coordinates) and, if applicable, the spatial orientation and the spatial extent of the volume area VB can be stored in the root node. Based on this data, the position of the voxels in the underlying hierarchy levels HE2, HE3 can be calculated so that their respective position does not have to be stored in the voxels of the underlying hierarchy levels.

In an advantageous embodiment of the invention, the voxel model or the associated tree structure has three hierarchy levels.

The volume area VB has a number of first partial volume areas TVB1, with each partial volume area TVB1 representing a voxel of the second hierarchy level HE2. For the sake of clarity, FIG. 2 shows 8 partial volume areas TVB1. However, it is particularly advantageous if the volume area VB has 4096 partial volume areas TVB1, with 16 partial volume areas being provided in each direction (i.e., 16×16×16 partial volume areas).

Each partial volume area TVB1 is represented in the tree structure by a node of the second hierarchy level HE2. The nodes of the second hierarchy level HE2 are son nodes of the root node WK. If 4096 partial volume areas TVB1 are provided in the second hierarchy level of the voxel model, then the tree structure in the second hierarchy level also has 4096 nodes.

Each partial volume area TVB1 of the second hierarchy level can have a number of second partial volume areas TVB2, with each partial volume area TVB2 representing a voxel of the third hierarchy level HE3. Each partial volume area TVB2 is represented in the tree structure by a node of the third hierarchy level HE3. The nodes of the third hierarchy level HE3 are son nodes of the respective node of the second hierarchy level.

According to an advantageous embodiment of the invention, not every partial volume area TVB1 of the second hierarchy level has to be subdivided into partial volume areas TVB2 on the third hierarchy level, as is apparent from the following description.

In the example shown in FIG. 2, only the partial volume area TVB1 of the second hierarchy level marked with the number 2 is subdivided into partial volume areas TVB2 of the third hierarchy level. For the sake of clarity, FIG. 2 shows 8 partial volume areas TVB2 in the third hierarchy level HE3 for the partial volume area marked with the number 2. However, it is particularly advantageous if the partial volume areas TVB1 each have 4096 partial volume areas TVB2, with 16 partial volume areas being provided in each direction (i.e., 16×16×16 partial volume areas).

If 4096 partial volume areas TVB2 of the third hierarchy level are provided in the third hierarchy level HE3 of the voxel model for a partial volume area TVB1 of the second hierarchy level, then the tree structure in the third hierarchy level HE3 for this partial volume area also has 4096 nodes.

If all partial volume areas TVB1 of the second hierarchy level have 4096 partial volume areas TVB2 of the third hierarchy level, then the third hierarchy level has about 16 million partial volume areas TVB2 (i.e., 4096×4096 partial volume areas). The entire volume area VB, in which the 3D model is modeled, can therefore be divided into approximately 16 million partial volume areas TVB2.

For most practical applications, this resolution of the volume area VB is usually sufficient. If a greater level of detail is required for the printed object, the spatial extent of the volume area VB can be reduced, resulting in smaller voxels on the second and third hierarchy levels. If necessary, part of the 3D model must be described using further volume areas.

According to the invention, it is provided that each voxel is assigned a distance attribute in which the distance of the respective voxel to the surface of the object, i.e., to the surface of the 3D model, can be stored. The value of the distance attribute is stored in the respective node of the tree structure.

If distance values are stored in the nodes on the third hierarchy level HE3, no distance value needs to be stored in the corresponding nodes on the second hierarchy level HE2.

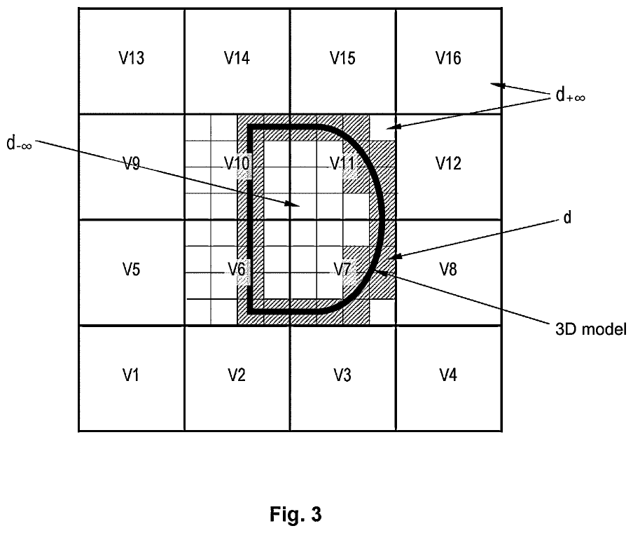

If, however, all voxels of a partial volume area TVB2 in the third hierarchy level HE3 have the same distance to the surface of the 3D model, it is not necessary to store the distance in the corresponding nodes of the tree structure—in this case it is sufficient to store the distance only in the corresponding node of the second hierarchy level HE2. The corresponding nodes in the third hierarchy level HE3 can remain empty and do not have to be stored—this can, on the one hand, lead to a considerable reduction in storage requirements, and, on the other hand, operations on the tree structure can be significantly accelerated. A concrete example of this is described below with reference to FIG. 3.

In the example of the voxel model shown in FIG. 2, the 3D model is completely located in the voxel of the second hierarchy level HE2 marked with the number 2. The remaining voxels of the second hierarchy level HE2 are therefore all located outside the 3D model and thus do not belong to the 3D model. Accordingly, it is advantageous to store the distance values only for those voxels of the third hierarchy level HE3 in the tree structure (in the son nodes that belong to the node of the second hierarchy level HE2 marked with the number 2) that belong to the voxel of the second hierarchy level HE2 marked with the number 2. For all other nodes of the second hierarchy level HE2, it is not necessary to store son nodes (nodes of the third hierarchy level HE3). In the example shown in FIG. 2 with a maximum of 8 nodes in the third hierarchy level HE3, only 8 nodes of the third hierarchy level HE3 need to be stored instead of 64 nodes.

Overall, this results in a storage-optimized tree structure that can still be used to model the 3D object precisely. The advantages of this tree structure are particularly noticeable in 3D models in which the volume area VB has partial volume areas TVB1 that do not belong to the 3D model—the more such partial volume areas TVB1 there are, the lower the storage requirement for storing the entire tree structure.

It may be necessary to store further attributes for the voxels of the 3D model in addition to the distance values, for example an attribute that specifies the color of the voxels and/or the material with which the voxel is to be printed.

According to the invention, the values of the additional attributes are stored in a separate tree structure, wherein it is advantageous if a separate tree structure is provided for each attribute. Each further tree structure has the same number of hierarchy levels as the tree structure in which distance attributes are stored. All tree structures represent the same volume area.

Storing the attribute values of the further attributes in the nodes of the respective tree structure is carried out in an analogous manner as explained above with regard to the distance attribute. In particular, it is not necessary to store attribute values in the third hierarchy level HE3 if the voxels belonging to a partial volume area TVB1 all have the same attribute value (e.g., the same color or the same material)—it is then sufficient if the corresponding attribute value n is stored in the corresponding node of the second hierarchy level HE2.

Storing different attributes in separate tree structures has the advantage that the 3D model can be processed with regard to one attribute independently of the other attributes. Another substantial advantage is that the tree structure for each attribute can be generated in a storage-optimized manner-if, for example, the voxels of a partial volume area TVB2 have different distance values but identical color values, then the distance values are stored in the nodes of the third hierarchy level HE3 and the color value can be stored in the corresponding node of the second hierarchy level HE2; there is no need to store the color values in the nodes of the third hierarchy level HE3.

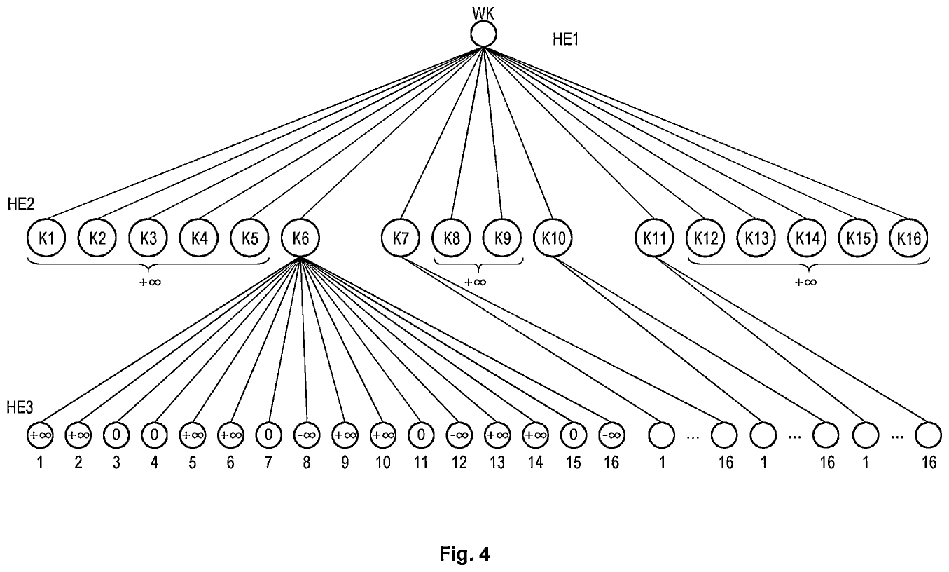

FIG. 3 shows an exemplary level of a voxel model (section through the voxel model) to illustrate the storage of the distance attributes, and FIG. 4 shows the section of a tree structure corresponding to the example in accordance with FIG. 3.

The voxel model on which FIG. 3 and FIG. 4 are based has 64 voxels in the second hierarchy level (4 voxels in each dimension) and 64 voxels in the third hierarchy level (4 voxels in each dimension) for each voxel in the second hierarchy level.

The level shown here comprises a section of a 3D model that represents a corresponding section of the object to be printed.

The level of the voxel model shown here comprises 16 voxels V1 to V16 in the second hierarchy level HE2. Accordingly, the tree structure also has 16 nodes K1 to K16 in the second hierarchy level. The remaining nodes of the second hierarchy level are not shown in FIG. 4.

The voxels V6, V7, V10, and V11 comprise the section of the 3D model. These voxels each have 16 voxels in the third hierarchy level, wherein it is assumed in this example that the respective voxels in the third hierarchy level have at least partially different distances to the surface of the 3D model. Accordingly, the tree structure for the corresponding nodes K6, K7, K10, and K11 each has 16 sub-nodes on the third hierarchy level, which represent the voxels in the third hierarchy level. In FIG. 4, all 16 sub-nodes 1 to 16 of the third hierarchy level are shown for node K6, while, for reasons of clarity, only the sub-nodes 1 and 16 of the third hierarchy level are shown for each of the nodes K7, K10, and K11. The respective distance to the surface of the 3D model is stored in the sub-nodes 1 to 16 of node K6, so that the value +∞(=the respective voxel lies outside the 3D model) is stored in the sub-nodes 1, 2, 5, 6, 9, 10, 13, and 14, the value −∞(=the respective voxel lies within the surface of the 3D model) is stored in the sub-nodes 8, 12, and 16, and the specific distance value (here, by way of example, the value 0) is stored in the sub-nodes 3, 4, 7, 11, and 15. The same method is used for the sub-nodes of nodes K7, K10, and K11.

The remaining voxels V1 to V5, V8, V9, and V12 to V16 lie completely outside the surface of the 3D model. According to the invention, the voxels V1 to V5, V8, V9, and V12 to V16 of the second hierarchy level therefore have no voxels in the third hierarchy level, so that corresponding nodes in the third hierarchy level of the tree structure can be dispensed with. The distance value too (=predetermined first distance) is therefore stored in the corresponding nodes K1 to K5, K8, K9, and K12 to K16 of the second hierarchy level of the tree structure, where too indicates that the corresponding voxel of the second hierarchy level lies outside the 3D model and therefore does not belong to the object to be printed.

As can be seen from this example, for the level of the voxel model shown here, only 16 sub-nodes (i.e., a total of 64 nodes at hierarchy level HE3) need to be stored in the tree structure for each of the nodes K6, K7, K10, and K11. For the remaining nodes K1 to K5, K8, K9, and K12 to K16, the 16 sub-nodes (a total of 192 nodes at hierarchy level HE3) can be dispensed with.

Based on the voxel model or based on the tree structure, the control instructions for controlling the 3D printer are derived or generated. In one embodiment of the invention, corresponding control instructions are generated for each level of the voxel model, wherein the control instructions specify which voxel belongs to the object to be printed. The distance values stored in the tree structure can be used for this-if the distance value is different from too, the corresponding voxel belongs to the object to be printed.

It is advantageous if the second hierarchy level of the tree structure is processed first:
if a distance value is stored in a node of the second hierarchy level, it is assumed that all sub-nodes of this node also have this distance value (even if these sub-nodes are not stored in the tree structure). According to the invention, corresponding control instructions are then generated for these nodes that are not stored in the tree structure. Iteration over the sub-nodes is thus avoided.

If no distance value is stored in a node of the second hierarchy level, these must be stored in the corresponding sub-nodes. Corresponding control instructions are then generated based on the distance values stored in the sub-nodes.

The control instructions can be stored in the data processing apparatus for transmission to the 3D printer.

1. A computer-implemented method for generating a 3D model of a physical object for controlling a 3D printer by means of control instructions, derived from the generated 3D model, for printing the object in the 3D printer, wherein a surface representation of the physical object is converted into a voxel model (VM) representing the 3D model, wherein
the surface representation is divided into a number of volume areas (VB), wherein each volume area is represented by a first tree structure (B), wherein the first tree structure (B)
comprises at least one root node (WK), and
has a predetermined maximum first number of hierarchy levels, and a predetermined second number of sub-nodes (IK, BK) can be assigned to each node (WK, IK) of a hierarchy level, wherein
the root node (WK) represents the volume area (VB),
the sub-nodes (IK) of the root node (WK) represent partial volume areas (TVB1) of the volume area represented by the root node (WK),
the sub-nodes (IK, BK) of a sub-node (IK) represent partial volume areas (TVB2) of the partial volume area represented by the respective sub-node (IK), and
the volume area (VB) and the partial volume areas (TVB1, TVB2) each represent a voxel (VX) of the voxel model (VM),
each voxel (VX) is assigned a distance attribute in which the distance of the respective voxel (VX) to the surface of the object can be stored,
wherein, when generating the voxel model (VM) representing the 3D model, a minimum distance (d_{MIN}) to the surface of the object is determined for each voxel (VX), wherein
for each voxel (VX) whose absolute minimum distance (d_{MIN}) is below a predetermined threshold value (dMAX), a distance (d) is stored in the distance attribute,
for each voxel (VX) whose absolute minimum distance (d_{MIN}) is above the predetermined threshold value (dMAX), a predetermined distance (d_{±∞}) is stored in the distance attribute, and
for each partial volume area (TVB1, TVB2) the distance (d) and/or the predetermined distance (d_{±∞}) of the respective voxels (VX) is only stored if it additionally fulfills a predetermined storage criterion, and
wherein
the control instructions for controlling the 3D printer are derived from the first tree structure (B) and the voxels (VX) stored in the first tree structure (B), wherein the control instructions comprise information on the areas in a print space of the 3D printer at which a print material belongs to the object, wherein these areas are determined by those voxels for which a distance (d) is stored in the distance attribute, and
the control instructions are provided for transmission to the 3D printer.

2. The method of claim 1, wherein
the predetermined maximum number of hierarchy levels is three, so that the first tree structure (B) has a maximum of three hierarchy levels, wherein the root node (WK) is the first hierarchy level,
the predetermined number of sub-nodes is 4096, so that 4096 sub-nodes (IK, BK) can be assigned to each node (WK, IK) of a hierarchy level, with the exception of the lowest hierarchy level,
the nodes (IK) of the second hierarchy level represent 4096 first partial volume areas (TVB1) of the volume area (VB),
the nodes (BK) of the third hierarchy level each represent 4096 second partial volume areas (TVB2) of the respective first partial volume area (TVB1).

3. The method of claim 1, wherein the predetermined storage criterion is selected from the group of storage criteria comprising at least
the minimum distance (d) of the voxel is different from the minimum distances of the other voxels of the respective partial volume range (TVB1, TVB2),
the difference between the voxel with the smallest minimum distance (d) and the voxel with the largest minimum distance (d) of the respective partial volume area (TVB1, TVB2) is above a predetermined second threshold value (d_{MAX2}).

4. The method of claim 3, wherein the second threshold value (d_{MAX2}) corresponds to the print resolution of the 3D printer, preferably at most half the print resolution of the 3D printer.

5. The method of claim 1, wherein the predetermined distance (d_{±∞}) comprises a predetermined first distance (d_{+∞}) and a predetermined second distance (d_{-∞}), wherein
for voxels that lie outside the surface of the object, the predetermined first distance (d_{+∞}), and
for voxels that lie within the surface of the object, the predetermined second distance (d_{-∞}) is stored in the distance attribute.

6. The method of claim 1, wherein in the root node (WK) the position of the first tree structure (B) in the three-dimensional space is stored with respect to the voxel model (VM) representing the 3D model.

7. The method of claim 1, wherein a further attribute can be assigned to each voxel (VX), wherein a property of the respective voxel is stored in the further attribute.

8. The method of claim 7, wherein the property is selected from the group comprising at least color, material, and combinations thereof.

9. The method of claim 7, wherein the further attribute is stored in a second tree structure (B2), wherein the second tree structure (B2) and the first tree structure (B) represent the same volume area.

10. The method of claim 9, wherein the number of hierarchy levels of the first tree structure (B) and the number of hierarchy levels of the second tree structure (B2) are identical, and wherein a predetermined third number of sub-nodes (IK, BK) can be assigned to each node (WK, IK) of a hierarchy level of the second tree structure (B2).

11. The method of claim 10, wherein the predetermined third number of sub-nodes is different from the predetermined second number of sub-nodes.

12. The method of claim 7, wherein the control instructions comprise information on the property stored in the further attribute.

13. The method of claim 7, wherein the group of storage criteria further comprises
the attribute value of the further attribute is different from the attribute values of the further attribute of the remaining voxels of the respective partial volume area (TVB1, TVB2).
